(19) United States
(12) Patent Application Publication
(10) Pub. No.: US 2009/0031719 A1
(43) Pub. Date: Feb. 5, 2009

(54) Hydraulic Drive System

(76) Inventors: Yasutaka Tsuruga, Moriyama-shi (JP); Junya Kawamoto, Moriyama-shi (JP); Kiwamu Takahashi, Kouka-shi (JP); Kenji Itou, Youkaichi-shi (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/576,559

(22) PCT Filed: May 8, 2006
(86) PCT No.: PCT/JP2006/309246

§ 371 Date: Apr. 3, 2007

(30) Foreign Application Priority Data
Jul. 13, 2005 (JP) 2005-204328

(51) Int. Cl. F15B 11/17; F15B 13/06

(52) U.S. Cl. 60/420

(57) ABSTRACT

The hydraulic drive system comprises an engine 1, a pump unit 100, a plurality of actuators 5a, 5b and 5c, a control valve unit 4, and engine revolution speed detecting means 4f. The pump unit 100 includes a pump tilting control mechanism 8 for load sensing control, and the control valve unit 4 includes a plurality of flow control valves 15a, 15b and 15c and pressure compensation valves 10a, 10b and 10c. The engine revolution speed detecting means 4f includes a first differential pressure reducing valve 14 for outputting, as an absolute value, a pressure depending on an engine revolution speed. The output pressure of the first differential pressure reducing valve 14 is introduced, as a target load-sensing differential pressure, to the pump tilting mechanism 8 via a line 127.

### TECHNICAL FIELD

The present invention relates to a hydraulic drive system for use in a construction machine such as a hydraulic excavator. More particularly, the present invention relates to a hydraulic drive system in which load sensing control is performed so as to hold the delivery pressure of a hydraulic pump higher than a maximum load pressure among a plurality of actuators by a target differential pressure, and in which the target differential pressure in the load sensing control is set as a variable value depending on an engine revolution speed.

### BACKGROUND ART

That type of hydraulic drive system is disclosed in, for example, JP,A 5-99126 (Patent Document 1) and JP,A 10-196604 (Patent Document 2). In that prior art, the flow rate of a hydraulic fluid supplied to each actuator is controlled by a hydraulic pump subjected to load sensing control and a control valve (flow control valve). The differential pressure across the flow control valve is controlled by a pressure compensation valve to a differential pressure between the delivery pressure of a hydraulic pump and a maximum load pressure among a plurality of actuators, and that differential pressure is controlled to a target load-sensing differential pressure by the load sensing control. The target load-sensing differential pressure is set as a variable value depending on an engine revolution speed.

Patent Document 1: JP,A 5-99126

Patent Document 2: JP,A 10-196604

### DISCLOSURE OF THE INVENTION

### Problems to be Solved by the Invention

In the known hydraulic drive system, as described above, the differential pressure across the control valve, i.e., the flow control valve, is controlled by the pressure compensation valve to the differential pressure between the delivery pressure of the hydraulic pump and the maximum load pressure among the plurality of actuators, and that differential pressure is controlled to the target load-sensing differential pressure by the load sensing control. As a result, the differential pressure across the control valve, i.e., the flow control valve, is controlled to the target load-sensing differential pressure (variable value). An opening area of the flow control valve is set so that the hydraulic fluid flows at a flow rate to be set at the target load-sensing differential pressure (i.e., the differential pressure across the control valve). Assuming that the opening area of the flow control valve is A, the target load-sensing differential pressure is Pgr, and the flow rate to be set is Qa, the relationship among those parameters is expressed by;

Qa=cA{(2/ρ)Pgr}^{1/2}

where c is a flow rate coefficient and ρ is a density of the hydraulic fluid.

In Patent Document 1, the target load-sensing differential pressure Pgr in the above formula is set by a pump displacement control valve (part of a pump unit) associated with the hydraulic pump, and the opening area A is set by a main spool (flow control valve) of the control valve. Thus, the flow rate Qa to be set is decided depending on respective specifications (Pgr and A) of two different units of hydraulic equipment (i.e., the pump unit and the control valve).

Also, in Patent Document 2, the target load-sensing differential pressure Pgr is set by a flow detection valve, and the opening area A is set by the flow control valve of the control valve. Thus, Pgr and A are likewise decided by two different units of hydraulic equipment.

In the prior art, as described above, because the flow rate to be set by the flow control valve is set depending on respective specifications of two different units of hydraulic equipment, that flow rate, i.e., the actuator speed of a hydraulic excavator, is affected by variations in performance of the different units of hydraulic equipment and mass productivity is deteriorated. Further, when a similar equipment arrangement is employed in various models, efficiency in simultaneous production of various models is also deteriorated due to, for example, false combinations in assembly of paired components.

An object of the present invention is to provide a hydraulic drive system which can improve mass productivity and efficiency in simultaneous production of various models.

### Means for Solving the Problems

(1) To achieve the above object, the present invention provides a hydraulic drive system comprising an engine; a pump unit including a variable-displacement first hydraulic pump and a fixed-displacement second hydraulic pump which are driven by the engine; a plurality of actuators driven by a hydraulic fluid delivered from the first hydraulic pump; and a control valve unit for controlling flow rates of the hydraulic fluid supplied from the first hydraulic pump to the plurality of actuators, the pump unit incorporating load sensing control means which includes a load sensing control valve for controlling a delivery pressure of the first hydraulic pump to be held higher than a maximum load pressure among the plurality of actuators, the control valve unit including a plurality of flow control valves and a plurality of pressure compensation valves for controlling differential pressures across the plurality of flow control valves to be each equal to a differential pressure between the delivery pressure of the hydraulic pump and the maximum load pressure among the plurality of actuators, wherein the hydraulic drive system further comprises engine revolution speed detecting means including a flow detection throttle for converting a delivery rate of the second hydraulic pump to a differential pressure across the flow detection throttle, and a first differential pressure reducing valve for detecting, as an absolute value, the differential pressure across the flow detection throttle; and a pilot hydraulic source formed downstream of the flow detection throttle, wherein the engine revolution speed detecting means and the pilot hydraulic source are included in the control valve unit, and wherein the pump unit and the control valve unit are connected to each other by a plurality of lines including first and second lines, a hydraulic fluid delivered from the second hydraulic pump is introduced to the flow detection throttle via the first line, and an output pressure of the first differential pressure reducing valve is introduced, as a target load-sensing differential pressure, to the load sensing control valve via the second line.

Thus, the engine revolution speed detecting means and the pilot hydraulic source, which are fundamentally present in the pump unit side, are included in the control valve unit side, the pump unit and the control valve are connected to each other by the lines, and the hydraulic fluid delivered from the second hydraulic pump and the output pressure of the first differential pressure reducing valve are introduced respectively to the flow detection throttle and the load sensing control valve. Therefore, the flow rate to be set by the flow control valve can be decided only depending on performance in the control valve unit side, and an actuator speed in a load sensing system can be controlled depending on the performance of the control valve unit alone. As a result, it is possible to improve mass productivity and to avoid, for example, false combinations in assembly of paired components, thus increasing the efficiency in simultaneous production of various models even when a similar equipment arrangement is employed in various models.

(2) In above (1), preferably, the plurality of lines connecting the pump unit and the control valve unit further include a third line, and a pressure of the hydraulic pressure source is introduced to an inlet port of the load sensing control valve via the third line.

With those features, the pressure of the hydraulic pressure source in the control valve unit side can be utilized by the load sensing control valve in the pump unit side.

(3) In above (1) or (2), preferably, the hydraulic drive system further comprises a second differential pressure reducing valve for outputting, as an absolute pressure, the differential pressure between the delivery pressure of the hydraulic pump and the maximum load pressure among the plurality of actuators, and the second differential pressure reducing valve is further included in the control valve unit, and the plurality of lines connecting the pump unit and the control valve unit further include a fourth line, and an output pressure of the second differential pressure reducing valve is introduced, as a control differential pressure, to the load sensing control valve via the fourth line.

With those features, the differential pressure between the delivery pressure of the hydraulic pump and the maximum load pressure among the plurality of actuators, which is detected in the control valve unit side, can be outputted as the absolute pressure, and the thus-outputted absolute pressure can be utilized by the load sensing control valve in the pump unit side.

(4) In above (1) to (3), preferably, the hydraulic drive system further comprises a pilot relief valve disposed downstream of the flow detection throttle and holding the pressure of the pilot hydraulic source at a constant pressure, and the pilot relief valve is further included in the control valve.

With those features, an equipment layout can be simplified.

(5) To achieve the above object, the present invention also provides a hydraulic drive system comprising an engine; a pump unit including a variable-displacement first hydraulic pump and a fixed-displacement second hydraulic pump which are driven by the engine; a plurality of actuators driven by a hydraulic fluid delivered from the first hydraulic pump; a control valve unit for controlling flow rates of the hydraulic fluid supplied from the first hydraulic pump to the plurality of actuators; and load sensing control means for controlling a delivery pressure of the first hydraulic pump to be held higher than a maximum load pressure among the plurality of actuators, the control valve unit including a plurality of flow control valves and a plurality of pressure compensation valves for controlling differential pressures across the plurality of flow control valves to be each equal to a differential pressure between the delivery pressure of the hydraulic pump and the maximum load pressure among the plurality of actuators, wherein the hydraulic drive system further comprises engine revolution speed detecting means including a flow detection throttle for converting a delivery rate of the second hydraulic pump to a differential pressure across the flow detection throttle, and a first differential pressure reducing valve for detecting, as an absolute value, the differential pressure across the flow detection throttle; and a pilot hydraulic source formed downstream of the flow detection throttle, wherein the engine revolution speed detecting means and the pilot hydraulic source are included in the control valve unit, and wherein the pump unit, the load sensing control means, and the control valve unit are connected to each other by a plurality of lines including first and second lines, a hydraulic fluid delivered from the second hydraulic pump is introduced to the flow detection throttle via the first line, and an output pressure of the first differential pressure reducing valve is introduced, as a target load-sensing differential pressure, to the load-sensing control means via the second line.

With those features, as in the above-described (1), the mass productivity and the efficiency in simultaneous production of various models can be both increased.

### Advantages of the Invention

According to the present invention, since the actuator speed in the load sensing system can be controlled only depending on the performance of the control valve unit, the mass productivity can be improved. Further, when a similar equipment arrangement is employed in various models, it is possible to avoid, for example, false combinations in assembly of paired components, and to improve the efficiency in simultaneous production of various models.

### BRIEF DESCRIPTION OF THE DRAWINGS

FIG. 1 shows, in the form of a hydraulic circuit diagram, a hydraulic drive system according to a first embodiment of the present invention.

FIG. 2 is a schematic view showing a machine body layout in the first embodiment, including an equipment installation layout and relations of line connections.

FIG. 3 is a schematic view showing an external appearance of a control valve unit.

FIG. 4 is a schematic view showing a machine body layout, similar to FIG. 2, the view representing, as Comparative Example 1, one example of the known hydraulic drive system.

FIG. 5 is a schematic view showing a machine body layout, similar to FIG. 2, the view representing, as Comparative Example 2, the known hydraulic drive system disclosed in JP,A 5-99126.

FIG. 6 shows, in the form of a hydraulic circuit diagram, a hydraulic drive system according to a second embodiment of the present invention.

FIG. 7 is a schematic view showing a machine body layout in the second embodiment, including an equipment installation layout and relations of line connections.

### REFERENCE NUMERALS

1 engine
2 hydraulic pump (main pump)
3 hydraulic pump (pilot pump)
4 control valve unit
4a, 4b, 4c valve sections
4d inlet section
4e first control section
4f second control section
5a, 5b, 5c actuators
6a, 6b shuttle valves
7 signal line
8 pump tilting control mechanism
8a horsepower control tilting actuator
8b LS control valve
8c LS control tilting actuator
8d pressure bearing sector
9 differential pressure reducing valve (second differential pressure reducing valve)
10a, 10b, 10c pressure compensation valves
11 flow detection valve
11a variable throttle (flow detection throttle)
11b, 11c pressure bearing sectors lid spring
12 pilot relief valve
13 oil tank
14 differential pressure reducing valve (first differential pressure reducing valve)
14a, 14b, 14c pressure bearing sectors
15a, 15b, 15c flow control valves
16 main relief valve
17 hydraulic fluid supply line
18 hydraulic fluid drain line
21 hydraulic line
21a hydraulic line
21b hydraulic line (pilot hydraulic source)
22, 23 hydraulic lines
25 pilot hydraulic source
31a, 31b, 31c pressure bearing sectors
33 hydraulic line
34 hydraulic drain line
35 hydraulic drain line
100 pump unit
110L, 110R caterpillar belts
112 upper turning body
114 front operating mechanism
121 main supply line
122 main return line
124-126 pilot lines
128 pilot line
129 drain line

### BEST MODE FOR CARRYING OUT THE INVENTION

Embodiments of the present invention will be described below with reference to the drawings.

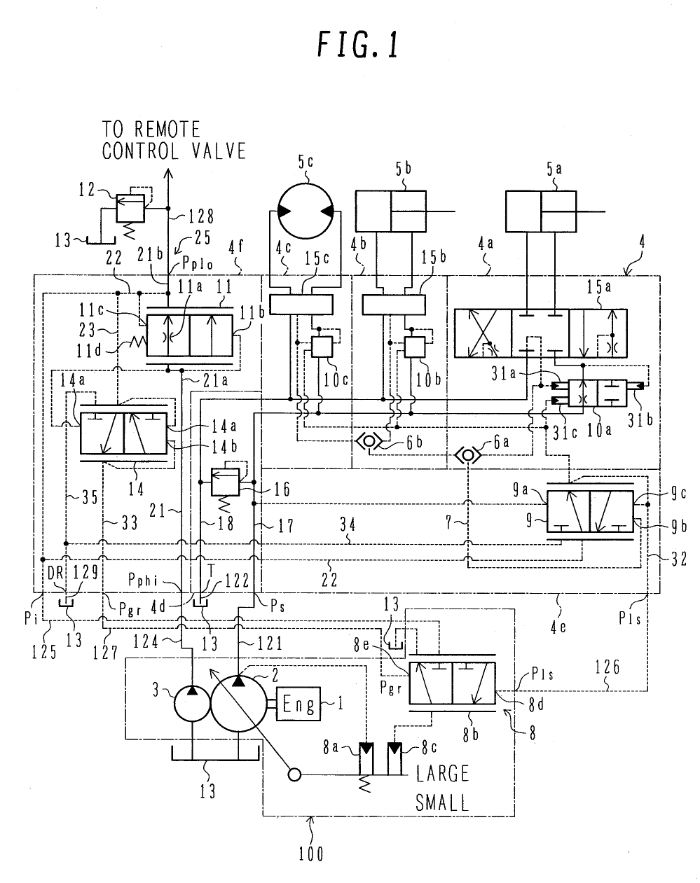

FIG. 1 shows a hydraulic drive system according to a first embodiment of the present invention.

In FIG. 1, the hydraulic drive system according to this first embodiment comprises an engine 1, a pump unit 100, a control valve unit 4, a plurality of actuators 5a, 5b and 5c, and an oil tank 13. The pump unit 100 includes a variable displacement hydraulic pump 2 serving as a main pump, a fixed displacement hydraulic pump 3 serving as a pilot pump, both the pumps being driven by the engine 1, and a pump tilting control mechanism 8 for controlling the tilting (displacement) of the hydraulic pump 2. The control valve unit 4 is made up of a plurality of valve sections 4a, 4b and 4c, an inlet section 4d, and first and second control sections 4e, 4f. Three valve sections 4a, 4b and 4c are shown corresponding to the actuators 5a, 5b and 5c, but a larger number of valve sections are actually disposed (as described later). Also, the first and second control sections 4e, 4f are shown as being two separate sections for convenience of illustration, but they are actually constructed as one unit of control section (as described later).

The plurality of valve sections 4a, 4b and 4c include a plurality of closed-center flow control valves (main spools) 15a, 15b and 15c for controlling respective flow rates and directions of a hydraulic fluid supplied from the hydraulic pump 2 to the actuators 5a, 5b and 5c, and a plurality of pressure compensation valves 10a, 10b and 10c for controlling differential pressures across respective meter-in throttles of the plurality of flow control valves 15a, 15b and 15c. The valve section 4a further includes a shuttle valve 6a for detecting maximum one (maximum load pressure) among load pressures taken out from respective load ports of the flow control valves 15a, 15b and 15c when the actuators 5a, 5b and 5c are driven, and for outputting the detected pressure to a signal line 7 in the first control section 4d. The valve section 4b further includes a shuttle valve 6b for detecting higher one between the load pressures taken out from the load ports of the flow control valves 15b, 15c when the actuators 5b, 5c are driven, and for outputting the detected pressure to the shuttle valve 6a.

The flow control valves 15a, 15b and 15c are shifted by operations of respective control levers (not shown), and opening areas of their meter-in throttles are decided depending on respective control inputs from those control levers.

The plurality of pressure compensation valves 10a, 10b and 10c are of the front-positioned type (before orifice type); namely they are disposed upstream of the respective meter-in throttles of the flow control valves 15a, 15b and 15c. The pressure compensation valve 10a has a pair of pressure bearing sectors 31a, 31b positioned in opposite relation, and a pressure bearing sector 31c acting in the valve opening direction. Respective pressures upstream and downstream of the flow control valve 15a are introduced to the pressure bearing sectors 31a, 31b, and the differential pressure across the flow control valve 15a is controlled by using, as a target compensation differential pressure, the pressure (described later) introduced to the pressure bearing sector 31c. The pressure compensation valves 10b, 10c are also similarly constructed. As a result, the differential pressures across the meter-in throttles of the flow control valves 15a, 15b and 15c are all controlled to have the same value such that the hydraulic fluid can be supplied at a ratio corresponding to the opening areas of the meter-in throttles of the flow control valves 15a, 15b and 15c regardless of the magnitudes of the load pressures.

The inlet section 4d includes a main relief valve 16, a hydraulic fluid supply line 17, and a hydraulic fluid drain line 18. The hydraulic fluid delivered from the hydraulic pump 2 is supplied to the pressure compensation valves 10a, 10b and 10c and the flow control valves 15a, 15b and 15c via the hydraulic fluid supply line 17 and is further supplied to the actuators 5a, 5b and 5c through the flow control valves 15a, 15b and 15c. The maximum pressure in the hydraulic fluid supply line 17 is limited to a setting pressure by the relief valve 16. The hydraulic fluid returned from the actuators 5a, 5b and 5c through the flow control valves 15a, 15b and 15c and the hydraulic fluid released from the relief valve 16 are both returned to the oil tank 13 via the hydraulic fluid drain line 18.

The first control section le includes a differential pressure reducing valve 9. The differential pressure reducing valve 9 has a pressure bearing sector 9a positioned on the side acting to increase its output pressure and pressure bearing sectors 9b, 9c positioned on the side acting to decrease its output pressure. The delivery pressure of the hydraulic pump 2 is introduced to the pressure bearing sector 9a, while the maximum load pressure outputted from the shuttle valve 6a to the signal line 7 and the output pressure of the differential pressure reducing valve 9 itself are introduced respectively to the pressure bearing sectors 9b, 9c. The differential pressure reducing valve 9 is operated based on balance among those introduced pressures to adjust a degree of communication between a hydraulic line 22 and a hydraulic drain line 34 so that an absolute value of the differential pressure (LS differential pressure) between the delivery pressure of the hydraulic pump 2 and the maximum load pressure is produced and outputted by using, as an original pressure, the pressure of a pilot hydraulic source (described later) which is created by the second control section 4f using the hydraulic fluid delivered from the hydraulic pump 3 (pilot pump). The output pressure of the differential pressure reducing valve 9 is introduced, as the target compensation differential pressure, to the pressure bearing sector 31c of the pressure compensation valve 10a and the similar pressure bearing sectors of the pressure compensation valves 10b, 10c. Thus, since the differential pressures across the meter-in throttles of the flow control valves 15a, 15b and 15c are controlled to be held at the LS differential pressure, the hydraulic fluid can be supplied at a ratio corresponding to the opening areas of the meter-in throttles of the flow control valves 15a, 15b and 15c even in a saturated state where the delivery rate of the hydraulic pump 2 does not satisfy a demanded flow rate. In addition, the output pressure of the differential pressure reducing valve 9 is also introduced, as a control differential pressure, to the pump tilting control mechanism 8 of the pump unit 100 via a hydraulic line 32.

The second control section 4f includes a flow detection valve 11 and a differential pressure reducing valve 14. The flow detection valve 11 has a variable throttle 11a serving as a flow detection throttle, the variable throttle 11a being disposed in a hydraulic line 21. The hydraulic line 21 is divided into an upstream hydraulic line 21a and a downstream hydraulic line 21b with the throttle 11a of the flow detection valve 11 positioned at a boundary. The upstream hydraulic line 21a is connected to the pilot pump 3, thus allowing the hydraulic fluid delivered from the pilot pump 3 to flow into the hydraulic line 21b through the hydraulic line 21a and the throttle 11a of the flow detection valve 11. The hydraulic line 21b is connected to a pilot relief valve 12 outside the control valve unit 4 such that a preset pressure is held by the relief valve 12 to form a pilot hydraulic source 25 in the hydraulic line 21b and in the downstream side thereof (i.e., the side downstream of the throttle 11a of the flow detection valve 11). The pilot hydraulic source 25 is connected, for example, to a remote control valve (not shown) for producing a pilot pressure used to shift the flow control valves 15a, 15b and 15c. The hydraulic line 21b serving as the pilot hydraulic source is connected to the differential pressure reducing valve 9 via the hydraulic line 22 and to the differential pressure reducing valve 14 via the hydraulic lines 22, 23, thereby supplying a pilot primary pressure. The hydraulic fluid released from the pilot relief valve 12 is returned to the oil tank 13.

The flow detection valve 11 and the differential pressure reducing valve 14 constitute revolution speed detecting means for detecting the revolution speed of the engine 1 based on the delivery rate of the hydraulic pump (pilot pump) 3 and for detecting, as an absolute pressure, a pressure depending on the detected engine revolution speed. The flow detection valve 11 converts the flow rate of the hydraulic fluid flowing through hydraulic line 21 to a differential pressure across the throttle 11a, and the differential pressure reducing valve 14 detects and outputs the converted differential pressure as an absolute pressure. The flow rate of the hydraulic fluid flowing through the hydraulic line 21 is the same as the delivery rate of the hydraulic pump 3, and the pump delivery rate is changed depending on the revolution speed of the engine 1. Accordingly, the revolution speed of the engine 1 can be detected by detecting the flow rate of the hydraulic fluid flowing through the hydraulic line 21 (i.e., the differential pressure across the throttle 11a).

Further, the throttle 11a is constituted as a variable throttle having an opening area continuously changed, and the flow detection valve 11 has a pressure bearing sector 11b acting in the throttle opening direction and a pressure bearing sector 11c and a spring 11d both acting in the throttle closing direction. The pressure upstream of the variable throttle 11a (i.e., the pressure in the hydraulic line 21a) is introduced to the pressure bearing sector 11b, and the pressure downstream of the variable throttle 11a (i.e., the pressure in the hydraulic line 21b) is introduced to the pressure bearing sector 11c, whereby the opening area of the variable throttle 11a is changed depending on the differential pressure across the variable throttle 11a itself.

The differential pressure reducing valve 14 has a pressure bearing sector 14a positioned on the side acting to increase its output pressure and pressure bearing sectors 14b, 14c positioned on the side acting to decrease its output pressure. The pressure upstream of the throttle 11a of the flow detection valve 11 is introduced to the pressure bearing sector 14a, while the pressure downstream of the throttle 11a and the output pressure of the differential pressure reducing valve 14 itself are introduced respectively to the pressure bearing sectors 14b, 14c. The differential pressure reducing valve 14 is operated based on balance among those introduced pressures to adjust a degree of communication between the hydraulic line 23 and a hydraulic drain line 35 so that an absolute value of the differential pressure across the throttle 11a is produced and outputted by using, as an original pressure, the pressure in the hydraulic line 21b (pilot hydraulic source). The output pressure of the differential pressure reducing valve 14 is introduced, as the target load-sensing differential pressure, to the pump tilting control mechanism 8 of the pump unit 100 via a hydraulic line 33. The surplus hydraulic fluid generated when the absolute pressure is produced is returned to the oil tank 13 via a hydraulic drain line 34.

The pump tilting control mechanism 8 of the pump unit 100 comprises a horsepower control tilting actuator 8a, an LS control valve 8b, and an LS control tilting actuator 8c. The horsepower control tilting actuator 8a is connected to a delivery port of the main hydraulic pump 2, and it functions to reduce the tilting amount of the hydraulic pump 2, thereby reducing the absorption horsepower of the hydraulic pump 2, as the delivery pressure of the hydraulic pump 2 increases. The LS control valve 8b and the LS control tilting actuator 8c constitute load sensing control means for executing control so that the delivery pressure of the hydraulic pump 2 is held higher than the maximum load pressure among the plurality of actuators 5a, 5b and 5c. The LS control valve 8b has pressure bearing sectors 8d, 8e positioned in opposite relation. The pressure bearing sector 8d is positioned on the side acting to increase a pressure applied to the LS control tilting actuator 8c, thereby reducing the tilting amount of the hydraulic pump 2, and the pressure bearing sector 8e is positioned on the side acting to reduce the pressure applied to the actuator 8c, thereby increasing the tilting amount of the hydraulic pump 2. The output pressure of the differential pressure reducing valve 9 (i.e., the differential pressure between the delivery pressure of the hydraulic pump 2 and the maximum load pressure among the actuators 5a, 5b and 5c) is introduced, as the control differential pressure, to the pressure bearing sector 8d. The output pressure of the differential pressure reducing valve 14 is introduced, as the target differential pressure for the load sensing control (i.e., the target load-sensing differential pressure), to the pressure bearing sector 8e. With such an arrangement, the LS control valve 8b and the LS control tilting actuator 8c jointly control the tilting amount (displacement) of the hydraulic pump 2 so that the delivery pressure of the hydraulic pump 2 is held higher than the maximum load pressure among the plurality of actuators 5a, 5b and 5c by the target load-sensing differential pressure.

Here, the target load-sensing differential pressure is set by the output pressure of the differential pressure reducing valve 14, and the output pressure of the differential pressure reducing valve 14 is given by the differential pressure across the throttle 11a of the flow detection valve 11, which is changed depending on the revolution speed of the engine 1. As a result, the differential pressure (target compensation differential pressure) between the delivery pressure of the hydraulic pump 2 and the maximum load pressure is also changed depending on the engine revolution speed, whereby the differential pressures across the flow control valves 15a, 15b and 15c are changed, thus enabling each actuator speed to be set depending on the engine revolution speed. In addition, as described above, the throttle 11a of the flow detection valve 11 is variable and constituted to be able to change the opening area thereof depending on the differential pressure across itself. By employing the differential pressure across the throttle 11a as the target load-sensing differential pressure, it is possible to avoid a saturation phenomenon occurred depending on the engine revolution speed, and to obtain good fine operability when the engine revolution speed is set to a low level. That point is described in detail in JP,A 10-196604.

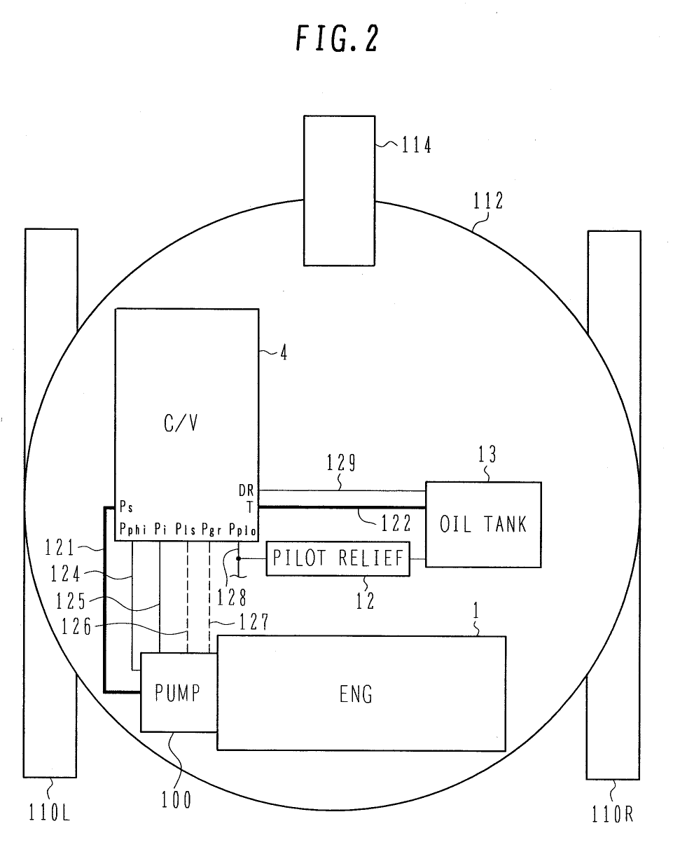

FIG. 2 is a schematic view showing a machine body layout including an equipment installation layout and relations of line connections.

In FIG. 2, a construction machine to which is applied the present invention is illustrated as a hydraulic excavator. The hydraulic excavator includes an upper turning body 112 mounted on a lower travel structure including left and right caterpillar belts 110L, 110R. A front operating mechanism 114, shown in the simplified form, is mounted to a front central portion of the upper turning body 112 in a vertically rotatable manner. On the upper turning body 112, the engine 1, the pump unit 100, the control valve unit 4, the pilot relief valve 12, and the oil tank 13 are disposed. The engine 1 and the pump unit 100 are disposed in a rear portion of a machine body. The control valve unit 4, the pilot relief valve 12, and the oil tank 13 are disposed in front of both the engine 1 and the pump unit 100.

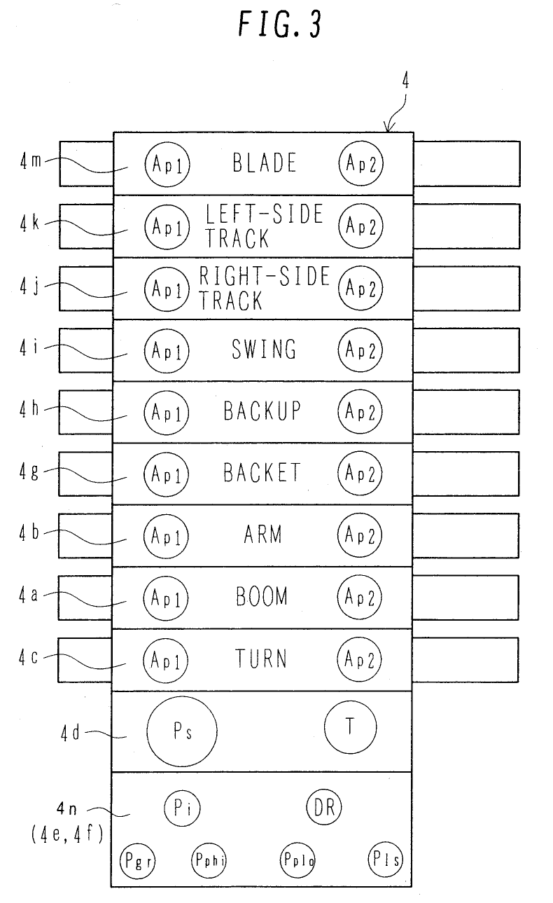

The control valve unit 4 has various ports, i.e., a main pump port Ps, a tank port T, a pilot pump port Pphi, a first pilot pressure port Pi, a second pilot pressure port Pplo, a drain port DR, a control differential pressure port Pls, and a target differential pressure port Pgr. The control valve unit 4 is connected at the main pump port Ps to the pump unit 100 via a main supply line 121 and is connected at the tank port T to the oil tank 13 via a main return line 122. Also, the control valve unit 4 is connected at the pilot pump port Pphi, the first pilot pressure port Pi, the control differential pressure port Pls, and the target differential pressure port Pgr to the pump unit 100 via the pilot lines 124, 125 and control pressure lines 126, 127, respectively. Further, the control valve unit 4 is connected at the second pilot pressure port Pplo to the pilot relief valve 12 via a pilot line 128 and is connected at the drain port DR to the oil tank 13 via a drain line 129. Further, the control valve unit 4 has a plurality of actuator ports (see FIG. 3), and these actuator ports are connected to the actuators 5a, 5b and 5c via main lines (not shown). Note that, for simplification of the drawing, those lines are not shown in FIG. 2.

Returning to FIG. 1, the main pump port Ps serves as an input port of the hydraulic fluid supply line 17, and the hydraulic fluid supply line 18 is connected to the main hydraulic pump 2 of the pump unit 100 via the main supply line 121. The tank port T serves as an output port of the hydraulic fluid drain line 18, and the hydraulic fluid drain line 18 is connected to the oil tank 13 via the main return line 122.

Further, the pilot pump port Pphi serves as an input port of the hydraulic line 21 (hydraulic line 21a), and the hydraulic line 21 (hydraulic line 21a) is connected to the pilot pump 3 via a pilot line 124, whereby the hydraulic fluid delivered from the pilot pump 3 is introduced to the throttle 11a of the flow detection valve 11 via the pilot line 124 and the hydraulic line 21a. The first pilot pressure port Pi serves as an output port of the hydraulic line 22, and the hydraulic line 22 is connected to an inlet port of the LS control valve 8b of the pump unit 100 via the pilot line 125, whereby the pressure in the hydraulic line 21b (pilot hydraulic source) is introduced to the inlet port of the LS control valve 8b via the hydraulic line 22 and the pilot line 125. The control differential pressure port Pls serves as an output port of the hydraulic line 32, and the hydraulic line 32 is connected to the pressure bearing sector 8d of the LS control valve 8b via the pilot line 126, whereby the output pressure of the differential pressure reducing valve 9 is introduced to the pressure bearing sector 8d of the LS control valve 8b via the hydraulic line 32 and the pilot line 126. The target differential pressure port Pgr serves as an output port of the hydraulic line 33, and the hydraulic line 33 is connected to the pressure bearing sector 8e of the LS control valve 8b via the pilot line 127, whereby the output pressure of the differential pressure reducing valve 14 is introduced to the pressure bearing sector 8e of the LS control valve 8b via the hydraulic line 33 and the pilot line 127. The second pilot pressure port Pplo serves as an output port of the hydraulic line 21b, and the hydraulic line 21b is connected to the pilot relief valve 12 and the remote control valve via the pilot line 128. The pilot line 128 forms the pilot hydraulic source 25 in cooperation with the hydraulic line 21b. The drain port DR serves as an output port of the hydraulic drain lines 34, 35, and the hydraulic drain lines 34, 35 are connected to the oil tank 13 via the drain line 129.

FIG. 3 is a schematic view showing an external appearance of the control valve unit 4. The control valve unit 4 is made up of a plurality of valve sections 4a, 4b, 4c, 4h, 4i, 4j, 4k and 4m, including the above-mentioned valve sections 4a, 4b and 4c, the inlet section 4d, and one control section 4n including the above-mentioned control sections 4e, 4f. The valve sections 4a, 4b, 4c, 4h, 4i, 4j, 4k and 4m are used in association with a boom, an arm, a turn, a bucket, backup, a swing, a right-side track, a left-side track, and a blade. Those valve sections incorporate pressure compensation valves including the pressure compensation valves 10a, 10b and 10c, and flow control valves including the flow control valves 15a, 15b and 15c. Further, each valve section is provided with actuator ports Ap1, Ap2 for connecting each flow control valve to the corresponding actuator. For simplification of the drawing, the valve sections 4h, 4i, 4j, 4k and 4m for the bucket, the backup, the swing, the right-side track, the left-side track, and the blade and the actuators associated with those valve sections are omitted in FIG. 1. The inlet section 4d is provided with the main pump port Ps and the tank port T. The control section 4n is provided with the pilot pump port Pphi, the first pilot pressure port Pi, the second pilot pressure port Pplo, the drain port DR, the control differential pressure port Pls, and the target differential pressure port Pgr. Further, the inlet section 4d incorporates the main relief valve 16, and the control section 4n incorporates the differential pressure reducing valve 9, the flow detection valve 11, and the differential pressure reducing valve 14.

The operation and advantages of the first embodiment thus constructed will be described below.

In this first embodiment, the load sensing control depending on the engine revolution speed can be performed, and therefore control of the actuator speed depending on the engine revolution speed can be realized. More specifically, when the engine revolution speed decreases, the target load-sensing differential pressure given by the output pressure of the differential pressure reducing valve 14 is lowered. Correspondingly, the differential pressure between the delivery pressure of the hydraulic pump 2 under the load sensing control and the maximum load pressure is lowered and so are the differential pressures across the flow control valves 15a, 15b and 15c, whereby the flow rates of the hydraulic fluid supplied to the actuators 5a, 5b and 5c are reduced. When the engine revolution speed increases, the target load-sensing differential pressure given by the output pressure of the differential pressure reducing valve 14 is raised. Correspondingly, the differential pressure between the delivery pressure of the hydraulic pump 2 under the load sensing control and the maximum load pressure is raised and so are the differential pressures across the flow control valves 15a, 15b and 15c, whereby the flow rates of the hydraulic fluid supplied to the actuators 5a, 5b and 5c are increased.

The flow rates of the hydraulic fluid supplied to the actuators 5a, 5b and 5c are decided respectively depending on the opening areas of the flow control valves 15a, 15b and 15c and the differential pressures across them. Therefore, assuming that the opening area of the flow control valve is An, the differential pressure across the flow control valve is Pls, and the flow rate is Qn, the flow rate Qn is defined by the following formula;

Qn=cAn{(2/ρ)Pls}^{1/2}

where c is a flow rate coefficient and ρ is a density of the hydraulic fluid.

Also, assuming that the target load-sensing differential pressure outputted from the differential pressure reducing valve 14 and introduced to be set in the LS control valve 8b is Pgr, the differential pressure between the delivery pressure of the hydraulic pump 2 and the maximum load pressure is controlled to become equal to the target load-sensing differential pressure Pgr by the LS control valve 8b and the LS control tilting actuator 8c of the pump tilting control mechanism 8. Further, the differential pressure Pls across the flow control valve is controlled to become equal to the differential pressure between the delivery pressure of the hydraulic pump 2 and the maximum load pressure by the corresponding pressure compensation valve 10a, 10b or 10c. Hence the differential pressure Pls across the flow control valve is controlled to become equal to the target load-sensing differential pressure Pgr (i.e., Pls=Pgr). As a result, the flow rate Qn is expressed by the following formula:

Qn=CAn{(2/ρ)Pgr}^{1/2}

In the above formula, the flow rate Qn is decided depending on the opening area An of each flow control valve 15a, 15b or 15c and the output pressure Pgr of the differential pressure reducing valve 14, and the output pressure Pgr of the differential pressure reducing valve 14 is the absolute value of the differential pressure across the flow detection valve 11. The flow control valves 15a, 15b and 15c, the flow detection valve 11, and the differential pressure reducing valve 14 (engine revolution speed detecting means) are disposed in the same single control valve unit 4. With such an equipment arrangement, the flow rate Qn can be decided only depending on the performance of the control valve unit 4.

That point will be described below in comparison with the prior art.

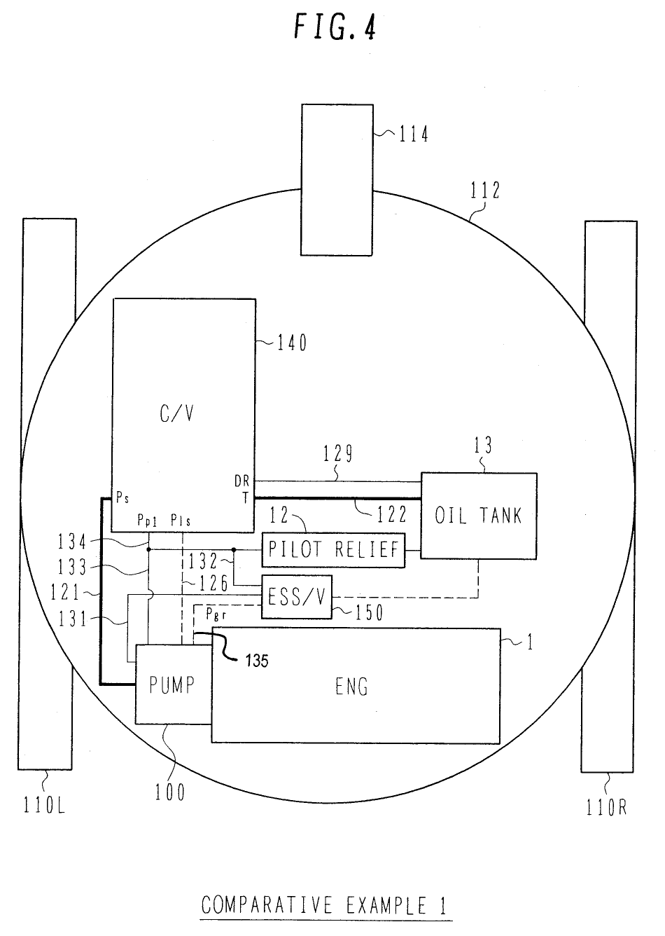

FIG. 4 is a schematic view showing a machine body layout, similar to FIG. 2, the view representing, as Comparative Example 1, one example of the known hydraulic drive system. Note that, in FIG. 4, similar components to those in FIG. 2 are denoted by the same reference numerals.

In FIG. 4, a hydraulic drive system of Comparative Example 1 comprises a pump unit 100, a control valve unit 140, and an engine revolution speed detecting unit 150 which is separate from the control valve unit 140. The control valve unit 140 has a construction obtained by omitting the second control section 4f from the control valve unit 4 shown in FIG. 1, and the engine revolution speed detecting unit 150 has a construction corresponding to the second control section 4f of the control valve unit 4 shown in FIG. 1. The engine revolution speed detecting unit 150 is connected to the pump unit 100 and a pilot relief valve 12 via pilot lines 131, 132 to create a pilot hydraulic source in the hydraulic line 21b downstream of the flow detection valve 11 by using the hydraulic fluid supplied from the pilot pump 3 in the pump unit 100, as described above with reference to FIG. 1. The pressure of the pilot hydraulic source is supplied, as the pilot primary pressure, to the LS control valve 8b in the pump unit 100 and the differential pressure reducing valve 9 in the control valve unit 140 via pilot lines 133, 134. Also, as described above with reference to FIG. 1, the engine revolution speed detecting unit 150 produces, as an absolute pressure, the pressure corresponding to the engine revolution speed by cooperation of the flow detection valve 11 and the differential pressure reducing valve 14, and the produced pressure (i.e., the output pressure of the differential pressure reducing valve 14) is supplied, as the target load-sensing differential pressure, to the LS control valve 8b in the pump unit 100 via a pilot line 135.

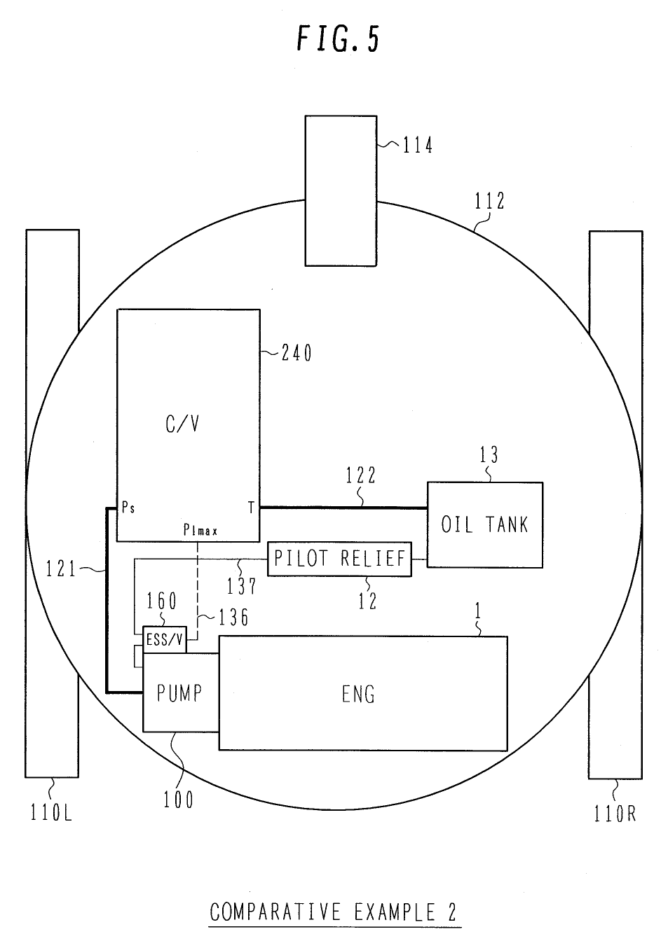

FIG. 5 is a schematic view showing a machine body layout, similar to FIG. 2, the view representing, as Comparative Example 2, the hydraulic drive system disclosed in JP,A 5-99126. Note that, in FIG. 5, similar components to those in FIG. 2 are denoted by the same reference numerals.

In FIG. 5, a hydraulic drive system of Comparative Example 2 comprises a pump unit 100, a control valve unit 240, and a pump displacement control valve 160 which is provided integrally with the pump unit 100. The control valve unit 140 has a construction obtained by omitting the first control section 4e and the second control section 4f from the control valve unit 4 shown in FIG. 1 such that the pump delivery pressure and the maximum load pressure are separately applied to the pressure compensation valve in opposite relation. Also, the maximum load pressure is introduced to the pump displacement control valve 160 being integral with the pump unit 100 via a pilot line 136. The pump displacement control valve 160 is connected to the pilot relief valve 12 via a pilot line 137 to create a pilot hydraulic source by using the hydraulic fluid supplied from the pilot pump in the pump unit 100, thereby producing a pressure corresponding to the engine revolution speed. The target load-sensing differential pressure is adjusted in accordance with the produced pressure for control of the displacement of the hydraulic pump.

In any of the known hydraulic drive systems described above, the target load-sensing differential pressure Pgr is set by the engine revolution speed detecting unit 150 or the pump displacement control valve 160 (part of the pump unit), which is separate from the control valve unit, and the opening area A is set by the main spool (flow control valve) of the control valve unit. Thus, the flow rate Qa to be set is decided depending on the respective specifications (Pgr and A) of two different units of hydraulic equipment (i.e., the pump unit and the control valve).

Stated another way, in the prior art, because the flow rate to be set by the flow control valve is set depending on respective specifications of two different units of hydraulic equipment, that flow rate, i.e., the actuator speed of a hydraulic excavator, is affected by variations in performance of the different units of hydraulic equipment and mass productivity is deteriorated. Further, when a similar equipment arrangement is employed in various models, efficiency in simultaneous production of various models is also deteriorated due to, for example, false combinations in assembly of paired components.

In contrast, according to this first embodiment, the flow rate to be set by each flow control valve 15a, 15b or 15c (i.e., the actuator speed of the hydraulic excavator in the load sensing system) can be controlled only by the control valve unit 4, and mass productivity can be improved. Further, even when a similar equipment arrangement is employed in various models, it is possible to avoid, for example, false combinations in assembly of paired components because combination of equipment for deciding performance is no longer required, and to prevent reduction of the efficiency in simultaneous production of various models.

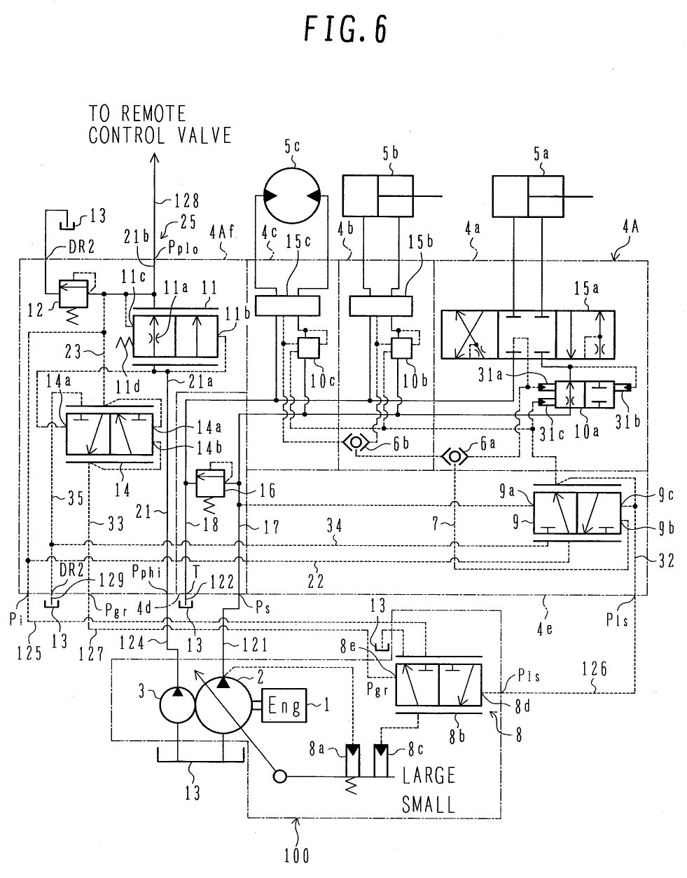

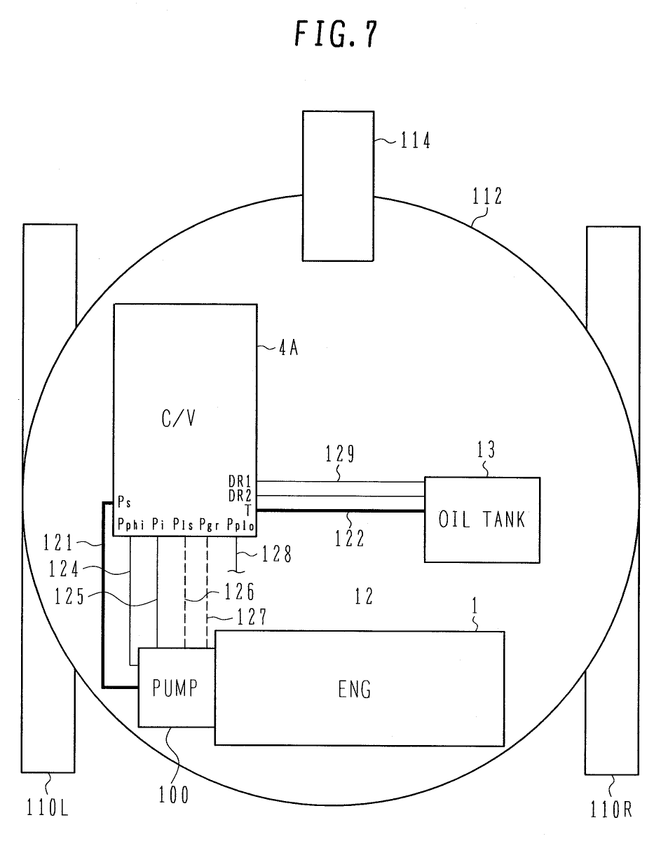

A second embodiment of the present invention will be described below with reference to FIGS. 6 and 7. FIG. 6 shows, in the form of a hydraulic circuit diagram, a hydraulic drive system according to the second embodiment, and FIG. 7 is a schematic view showing a machine body layout, including an equipment installation layout and relations of line connections, in the hydraulic drive system according to the second embodiment. Note that, in FIGS. 6 and 7, similar components to those in FIGS. 1 and 2 are denoted by the same reference numerals.

In FIG. 6, this second embodiment differs from the first embodiment, shown in FIG. 1, in that the pilot relief valve 12 disposed outside the control valve unit 4 in the first embodiment is incorporated in the control valve unit 4A.

This second embodiment can also provide similar advantages to those in the first embodiment. In addition, as shown in FIG. 7, this second embodiment is made up of just four units of hydraulic equipment, i.e., an engine 1, a pump unit 100, a control valve unit 4A, and an oil tank 13. Therefore, the layout of hydraulic equipment is further simplified.

It is to be noted that the present invention is not limited to the embodiments described above and can be modified and applied in various ways. For example, while the load sensing control means is hydraulically constituted by the LS control valve 8b and the LS control tilting actuator 8c in the above-described embodiments, the load sensing control means may be electro-hydraulically constituted by using pressure sensors, a controller, and a solenoid valve. In such a case, bay way of example, the output pressures of the differential pressure reducing valves 9, 14 are introduced to the pressure sensors via lines to detect the output pressures by the pressure sensors, and outputs of the pressure sensors are sent to the controller. The controller computes a control signal for controlling the tilting amount of the hydraulic pump 2 so that the differential pressure (i.e., the output pressure of the differential pressure reducing valve 9) between the delivery pressure of the hydraulic pump 2 and the maximum load pressure among the plurality of actuators 5a, 5b and 5c is held at the target load-sensing differential pressure (i.e., the output pressure of the differential pressure reducing valve 14), and it sends the control signal to the solenoid valve, thereby controlling the tilting amount of the hydraulic pump 2. Since the flow rate to be set by the flow control valve is decided only depending on performance on the control valve unit side, that modified case can also improve the mass productivity and increase the efficiency in simultaneous production of various models as in the first embodiment.

1. A hydraulic drive system comprising an engine; a pump unit including a variable-displacement first hydraulic pump and a fixed-displacement second hydraulic pump which are driven by said engine; a plurality of actuators driven by a hydraulic fluid delivered from said first hydraulic pump; and a control valve unit for controlling flow rates of the hydraulic fluid supplied from said first hydraulic pump to said plurality of actuators, said pump unit incorporating load sensing control means which includes a load sensing control valve for controlling a delivery pressure of said first hydraulic pump to be held higher than a maximum load pressure among said plurality of actuators, said control valve unit including a plurality of flow control valves and a plurality of pressure compensation valves for controlling differential pressures across said plurality of flow control valves to be each equal to a differential pressure between the delivery pressure of said first hydraulic pump and the maximum load pressure among said plurality of actuators,
wherein said hydraulic drive system further comprises engine revolution speed detecting means including a flow detection throttle for converting a delivery rate of said second hydraulic pump to a differential pressure across said flow detection throttle, and a first differential pressure reducing valve for detecting, as an absolute value, the differential pressure across said flow detection throttle; and
a pilot hydraulic source formed downstream of said flow detection throttle, and
wherein said engine revolution speed detecting means and said pilot hydraulic source are included in said control valve unit, and
wherein said pump unit and said control valve unit are connected to each other by a plurality of lines including first and second lines, a hydraulic fluid delivered from said second hydraulic pump is introduced to said flow detection throttle via said first line, and an output pressure of said first differential pressure reducing valve is introduced, as a target load-sensing differential pressure, to said load sensing control valve via said second line.

2. The hydraulic drive system according to claim 1,
wherein said plurality of lines connecting said pump unit and said control valve unit further include a third line, and a pressure of said hydraulic pressure source is introduced to an inlet port of said load sensing control valve via said third line.

3. The hydraulic drive system according to claim 1,
further comprising a second differential pressure reducing valve for outputting, as an absolute pressure, the differential pressure between the delivery pressure of said hydraulic pump and the maximum load pressure among said plurality of actuators,
wherein said second differential pressure reducing valve is further included in said control valve unit, and
said plurality of lines connecting said pump unit and said control valve unit further include a fourth line, and an output pressure of said second differential pressure reducing valve is introduced, as a control differential pressure, to said load sensing control valve via said fourth line.

4. The hydraulic drive system according to claim 1,
further comprising a pilot relief valve disposed downstream of said flow detection throttle and holding the pressure of said pilot hydraulic source at a constant pressure,
wherein said pilot relief valve is further included in said control valve unit.

5. A hydraulic drive system comprising an engine; a pump unit including a variable-displacement first hydraulic pump and a fixed-displacement second hydraulic pump which are driven by said engine; a plurality of actuators driven by a hydraulic fluid delivered from said first hydraulic pump; a control valve unit for controlling flow rates of the hydraulic fluid supplied from said first hydraulic pump to said plurality of actuators; and load sensing control means for controlling a delivery pressure of said first hydraulic pump to be held higher than a maximum load pressure among said plurality of actuators, said control valve unit including a plurality of flow control valves and a plurality of pressure compensation valves for controlling differential pressures across said plurality of flow control valves to be each equal to a differential pressure between the delivery pressure of said first hydraulic pump and the maximum load pressure among said plurality of actuators,
wherein said hydraulic drive system further comprises engine revolution speed detecting means including a flow detection throttle for converting a delivery rate of said second hydraulic pump to a differential pressure across said flow detection throttle, and a first differential pressure reducing valve for detecting, as an absolute value, the differential pressure across said flow detection throttle; and
a pilot hydraulic source formed downstream of said flow detection throttle,
wherein said engine revolution speed detecting means and said pilot hydraulic source are included in said control valve unit, and
wherein said pump unit, said load sensing control means, and said control valve unit are connected to each other by a plurality of lines including first and second lines, a hydraulic fluid delivered from said second hydraulic pump is introduced to said flow detection throttle via said first line, and an output pressure of said first differential pressure reducing valve is introduced, as a target load-sensing differential pressure, to said load-sensing control means via said second line
